(19) United States
(12) Patent Application Publication
(10) Pub. No.: US 2026/0365021 A1
(43) Pub. Date: Nov. 19, 2026

(54) SYSTEM AND METHOD FOR DIGITAL VEHICLE MURALS

(71) Applicant: American Honda Motor Co., Inc., Torrance, CA (US)

(72) Inventor: Cooper Koo SHIN, Huntington Beach, CA (US)

(21) Appl. No.: 19/210,140

(22) Filed: May 16, 2025

(51) Int. Cl. B60K 35/28; G06Q 10/1093

(52) U.S. Cl. CPC B60K 35/28; G06Q 10/1093; B60K 2360/1438; B60K 2360/1468; B60K 2360/182; B60K 2360/334; B60K 2360/741; B60K 2360/797

(57) ABSTRACT

The system and method allow users to collaboratively create digital murals on a vehicle’s windows and ground projection system, integrating multi-user input, AI-driven workspace management, and real-time interaction. Vehicle windows and the ground can be transformed into a multi-input digital drawing board. A digital toolbox stocked with drawing/painting tools can be displayed to users right on the drawing board. Users can import photos, write messages, draw images, and animate clip art. The system can simultaneously detect input from multiple users. Drawings can be transferred between windows, with the toolbox following along, ensuring a fun, engaging, and seamless experience. The disclosed system and method use a vehicle-integrated app to facilitate event planning, theme selection, and participant invitations with real-time previewing and control.

### TECHNICAL FIELD

The embodiments disclosed are related to creating digital murals displayed on and around vehicles. More specifically, the embodiments disclosed are related to dynamic digital murals.

### BACKGROUND

Vehicle windows have provided a canvas for advertisements and personal messages. Typically, advertisements are provided as laminations covering a surface of the window (e.g., stickers, banners, or decals). Personal messages are often written in shoe polish or window paint (e.g., window markers) on vehicle windows. However, these methods of decorating vehicle windows are static and cannot be easily changed, and result in difficulty cleaning. These methods also cannot apply decorations to vehicle windows remotely.

There is a need in the art for a system and method that addresses the shortcomings discussed above.

### SUMMARY

The disclosed system and method can enhance family engagement and digital creativity through interactive vehicle-based experiences. The system and method can allow users to collaboratively create digital murals on a vehicle’s windows and ground projection system, integrating multi-user input, AI-driven workspace management, and real-time interaction.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computer-implemented method of creating a digital mural. The computer-implemented method also includes receiving, at a vehicle-integrated app, a request to create an event from a first user’s device; upon receiving the request to create the event, automatically scheduling the event on a digital calendar and sending an electronic invitation to the scheduled event to users identified as participants by the first user’s device; receiving, at the vehicle-integrated app, a request to begin the scheduled event; upon receiving the request to begin the schedule event, sensing, by a position sensor, a participant’s position; upon sensing a participant’s position, assigning a display region on an exterior of the vehicle to the participant; displaying a digital toolbox on the assigned display region; and in response to the participant touching the display region, displaying an image based on a participant’s touch in the display region. Other embodiments of this aspect include corresponding computer systems, apparatus, and computer programs recorded on one or more computer storage devices, each configured to perform the actions of the methods.

One general aspect includes a system for creating a digital mural one or more computers and one or more storage devices storing instructions that are executable by the one or more computers to: receive, at a vehicle-integrated app, a request to create an event from a first user’s device; upon receiving the request to create the event, automatically schedule the event on a digital calendar and sending an electronic invitation to the scheduled event to users identified as participants by the first user’s device; receive, at the vehicle-integrated app, a request to begin the scheduled event; upon receiving the request to begin the schedule event, sense, by a position sensor, a participant’s position; upon sensing a participant’s position, assign a display region on the exterior of the vehicle to the participant; display a digital toolbox on the assigned display region; and in response to the participant touching the display region, display an image based on the participant’s touch in the display region. Other embodiments of this aspect include corresponding computer systems, apparatus, and computer programs recorded on one or more computer storage devices, each configured to perform the actions of the methods.

One general aspect includes a non-transitory computer-readable medium storing software that can include instructions that are executable by one or more computers to create a digital mural by: receiving, at a vehicle-integrated app, a request to create an event from a first user’s device; upon receiving the request to create the event, automatically scheduling the event on a digital calendar and sending an electronic invitation to the scheduled event to users identified as participants by the first user’s device; receiving, at the vehicle-integrated app, a request to begin the scheduled event; upon receiving the request to begin the schedule event, sensing, by a position sensor, a participant’s position; upon sensing a participant’s position, assigning a display region on the exterior of the vehicle to the participant; displaying a digital toolbox on the assigned display region; and in response to the participant touching the display region, displaying an image based on the participant’s touch in the display region. Other embodiments of this aspect include corresponding computer systems, apparatus, and computer programs recorded on one or more computer storage devices, each configured to perform the actions of the methods.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like reference numerals designate corresponding parts throughout the different views.

FIG. 1 is a schematic diagram of a system for creating digital murals displayed on and around vehicles, according to an embodiment.

FIG. 2 shows an organizer and a participant near a vehicle with a digital toolbox displayed on two display regions, according to an embodiment;

FIG. 3 shows participants creating images on display regions on a vehicle with their fingers as touch input, according to an embodiment;

FIG. 4 shows participants creating images on display regions on a ground around a vehicle with their feet as touch input, according to an embodiment;

FIG. 5 shows a user viewing an image of a vehicle with display regions displaying a mural, according to an embodiment;

FIG. 6 shows a computer-implemented method of creating digital murals displayed on and around vehicles, according to an embodiment.

Other systems, methods, features, and advantages of the disclosure will be, or will become, apparent to one of ordinary skill in the art upon examination of the following figures and detailed description. It is intended that all such additional systems, methods, features, and advantages be included within this description and this summary, be within the scope of the disclosure, and be protected by the following claims.

While various embodiments are described, the description is intended to be exemplary, rather than limiting, and it will be apparent to those of ordinary skill in the art that many more embodiments and implementations are possible that are within the scope of the embodiments. Although many possible combinations of features are shown in the accompanying figures and discussed in this detailed description, many other combinations of the disclosed features are possible. Any feature or element of any embodiment may be used in combination with or substituted for any other feature or element in any other embodiment unless specifically restricted.

This disclosure includes and contemplates combinations with features and elements known to the average artisan in the art. The embodiments, features, and elements that have been disclosed may also be combined with any conventional features or elements to form a distinct invention as defined by the claims. Any feature or element of any embodiment may also be combined with features or elements from other inventions to form another distinct invention as defined by the claims. Therefore, it will be understood that any of the features shown and/or discussed in the present disclosure may be implemented singularly or in any suitable combination. Accordingly, the embodiments are not to be restricted except in light of the attached claims and their equivalents. Also, various modifications and changes may be made within the scope of the attached claims.

### DESCRIPTION OF EMBODIMENTS

Generally disclosed are embodiments of systems and methods for creating digital murals displayed on and around vehicles. The disclosed system and method can transform car windows and the ground into a multi-input digital drawing board. A digital toolbox stocked with shapes, colors, brushes, and motion effects can be displayed to users right on the drawing board. Users can import photos, write messages, draw images, and animate clip art. The system can simultaneously detect input from multiple users. Drawings can be transferred between windows, with a toolbox following along each user, ensuring a fun, engaging, seamless, and clean experience.

The disclosed system and method ensure a seamless and organized event setup where users can customize and coordinate collaborative artwork remotely. The disclosed system and method can use a vehicle-integrated app to facilitate event planning, theme selection, and participant invitations with real-time previewing and control. Unlike existing vehicle display systems, this feature provides pre-event digital coordination and multi-user previewing of artistic compositions.

The vehicle-integrated app can sync with the vehicle computer system via a secure wireless protocol (e.g., Ultra-Wideband (UWB) or Bluetooth Low Energy), ensuring low-latency communication. The vehicle can be preloaded with event details, including a schedule, invitees, and real-time updates on drawing inputs.

For ground drawing, users can create images with one foot (or hand) and erase them with the other. Upon activation, the graphics light up with everyone's messages and drawings, fully animated for a heartfelt celebration. Family drawing data is combined with 360-camera footage capturing the reactions of those outside the vehicle. The content can be shared with others, allowing them to enjoy it live and later at any time. The intended recipient (e.g., person whose vehicle is the target of the mural or a vehicle passenger) can, for example, display a stationary image while driving and animate it when stopped. Alternatively, the displayed image(s) may be always stationary, always animated, or animated based on vehicle motion or on/off status.

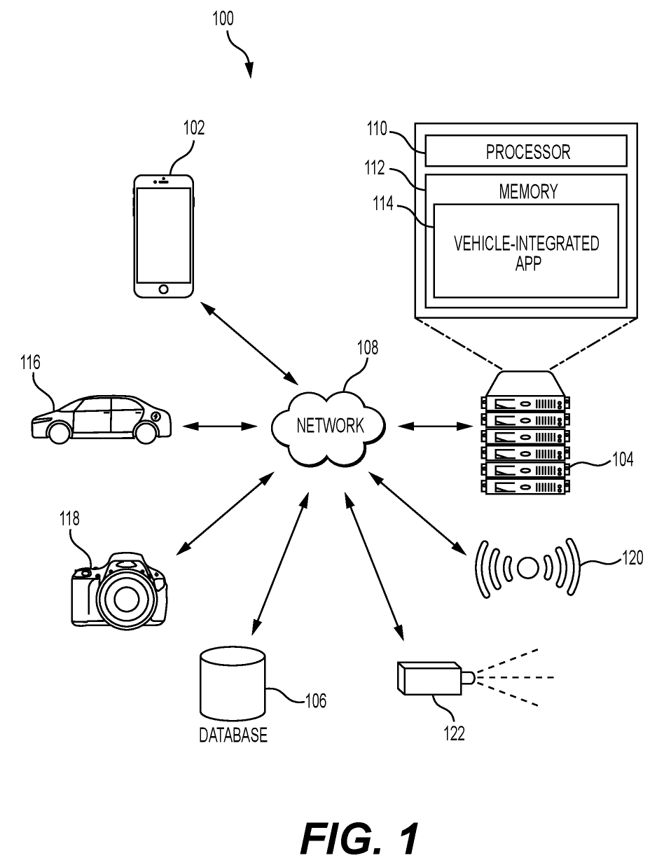

FIG. 1 is a schematic diagram of a system for creating digital murals displayed on and around vehicles 100 (or system 100), according to an embodiment. During use, a user may interact with the system to create a digital mural displayed on and around vehicles. The disclosed system may include a plurality of components capable of performing the disclosed computer implemented method. For example, system 100 includes a user device 102, a computing system 104, a vehicle 116, a camera 118, sensor 120, and a database 106. Database 106 can store user account information and event details.

The components of system 100 can communicate with each other through a communication network 108. For example, user device 102 can retrieve training data from database 106 via communication network 108. In some embodiments, communication network 108 may be a wide area network ("WAN"), e.g., the Internet. In other embodiments, communication network 108 may be a local area network ("LAN").

While FIG. 1 shows one user device, it is understood that one or more user devices may be used. For example, in some embodiments, the system may include two or three user devices. In some embodiments, the user devices may be computing devices used by a user. For example, user device 102 may include a smartphone or a tablet computer. In other examples, user device 102 may include a laptop computer, a desktop computer, and/or another type of computing device. The user devices may be used for inputting, processing, and displaying information. In some embodiments, a digital camera may be used to generate images used for analysis in the disclosed method. In some embodiments, the user device may include a digital camera that is separate from the computing device. In other embodiments, the user device may include a digital camera that is integral with the computing device, such as a camera on a smartphone or tablet.

As shown in FIG. 1, in some embodiments, a vehicle-integrated app 114 can be hosted in a computing system 104. Computing system 104 includes a processor 110 and a memory 112. Processor 110 may include a single device processor located on a single device, or it may include multiple device processors located on one or more physical devices. Memory 112 may include any type of storage, which may be physically located on one physical device, or on multiple physical devices. In some cases, computing system 104 may comprise one or more servers that are used to host the system.

In some embodiments, the vehicle-integrated app can include a mobile app that syncs with a vehicle's computer system via a secure wireless protocol (e.g., Ultra-Wideband or Bluetooth Low Energy) for instant communication.

While FIG. 1 shows a single user device, it is understood that more user devices may be used. For example, in some embodiments, the system may include two or three user devices. The user device may be a computing device used by a user for communicating with the system. In some embodiments, one or more of the user devices may include a smartphone or a tablet computer. In other embodiments, one or more of the user devices may include a laptop computer, a desktop computer, and/or another type of computing device. The user devices may be used for inputting, processing, and displaying information. The user device may include a display that provides an interface for the user to input and/or view information.

While FIG. 1 shows camera 118, it is understood that user device 102 or vehicle 116 can include a camera that can replace camera 118. For example, the vehicle can include ADAS stereo cameras that act as the cameras in the system. Additionally, the system may include multiple cameras, including a combination of different types of cameras.

Sensor 120 can include multiples sensors. In some embodiments, the sensors are position sensors. For example, the sensor can be Light Detection and Ranging (LIDAR) sensors and/or Advanced Driver Assistance Systems (ADAS) sensors.

The vehicle can also include a display system 122 that displays an image on surfaces (e.g., windows or panels) of the vehicle as well as surfaces surrounding the vehicle (e.g., the ground or walls of a garage). For example, a display system can include a ceiling-mounted projector and/or a projector mounted near the bottom surface of the vehicle’s frame. The projectors can include a laser projection system. The display system can include an interactive transparent window screen mounted on windows of the vehicle.

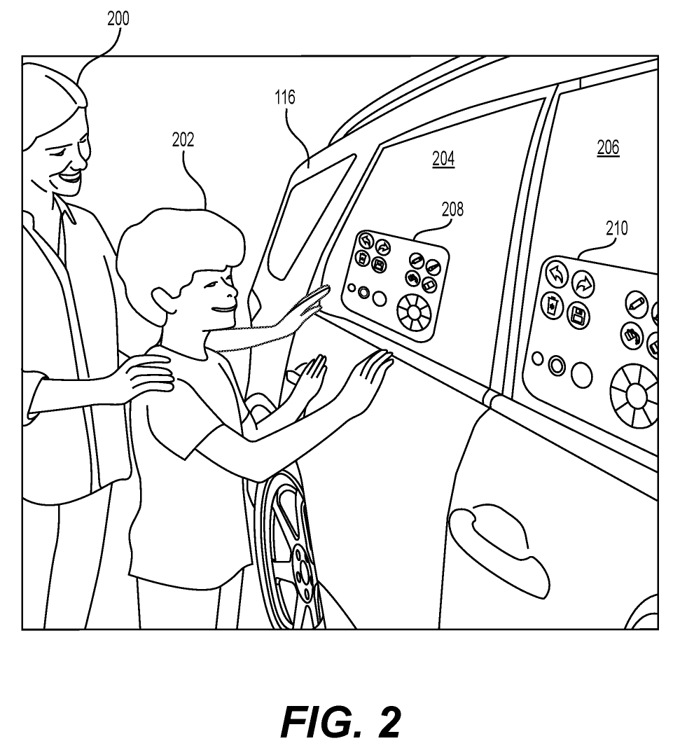

FIG. 2 shows an organizer 200 and a first participant 202 near vehicle 116 with a digital toolbox displayed by display system 122 on two display regions, according to an embodiment. A first digital toolbox 208 can be displayed on a first display region 204. A second digital toolbox 210 can be displayed on a second display region 206. In this example, the display regions are vehicle passenger side windows. It is understood that any portion of the vehicle and/or ground and/or surfaces surrounding the vehicle can be used as a display region.

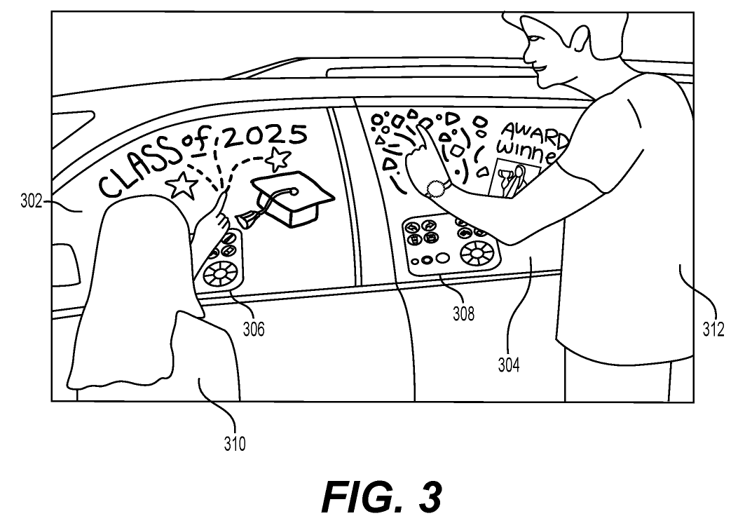

FIG. 3 shows a second participant 310 and a third participant 312 creating images/murals on display regions on a vehicle with their fingers as touch input, according to an embodiment. Second participant 310 is making a mural on a third display region 302. Third digital toolbox 306 is displayed on third display region 302. Third participant 312 is making a mural on a fourth display region 304. Fourth digital toolbox 308 is displayed on fourth display region 304.

The method can include receiving, at a vehicle-integrated app, a request to create an event from a first user’s device. For example, the first user’s device can include an event organizer’s smartphone, computer tablet, laptop, etc. The organizer can activate the vehicle-integrated app to begin creating an event by making selections available on the vehicle-integrated app.

The vehicle-integrated app can provide a template menu having options for the event organizer to select from. For example, the template menu can provide event themes, such as birthday, graduation, wedding, baby shower, etc. In another example, the template menu can provide color themes. The vehicle-integrated app can display a rendering of a preview of how the vehicle might look with a template for each theme.

An invitation system provided by the vehicle-integrated app can be integrated with calendar and messaging features, allowing scheduled event control. The method can include, upon receiving the request to create the event, automatically scheduling the event on a digital calendar and sending (e.g., by email or Short Message Service (SMS)) an electronic invitation for the scheduled event to users identified as participants by the first user’s device. For example, when creating the event on the vehicle-integrated app, the organizer can input a list of participants. In another example, the organizer can select participants from a list of contacts. In some situations, the event may be a surprise to an individual (such as the individual who is the subject of the birthday or graduation, etc.), and the organizer can exclude that individual from the list of participants to keep it a surprise. Participants that are unable to receive electronic invitations, such as pets and young children, may be inputted as a participant and designated as a dependent by a guardian participant. A photo of the dependent participant may be uploaded to the invitation system for identification later at the event.

To prevent unwanted murals in certain locations on or around the vehicle, the organizer may lock one or more display regions from participants (e.g., the front windshield and rear windshield). To organize the murals, the organizer may assign one or more display regions to each participant. The vehicle-integrated app may include options to perform the aforementioned controls.

It is noted that the organizer may or may not be a primary user or owner of the vehicle. Thus, the organizer may be required to receive authorization from a primary user or owner of the vehicle by first requesting permission through the vehicle-integrated app. Once the permission is granted by the primary user or owner, the organizer may perform the functions and controls throughout herein.

In some embodiments, the method can include beginning the scheduled event automatically at the scheduled time without prompting. In other embodiments, the method can include receiving, at the vehicle-integrated app, a request to begin the scheduled event. For example, the organizer can use the first user’s device to request for the scheduled event to begin remotely.

In other embodiments, the request can be automated from the first user’s device upon the vehicle computer system or the first user’s device detecting that the first user device is in communication range of the vehicle at or after the scheduled time. For example, an organizer may arrive at the vehicle, and the vehicle may detect the organizer’s smartphone (e.g., acting as the car key).

In some embodiments, recognizing the organizer standing next to the car, the system can track her precise location and verify her identity via face and/or voice recognition. For example, the vehicle can use UWB tracking to precisely locate the organizer. Face (or other biometrics) and/or voice recognition can confirm her admin role, using pre-registered data from the vehicle-integrated app. A popup window can appear on her side of the door window, showing her profile, the title of the event, and options to confirm starting the activity. The organizer can press “yes” to activate event mode. The organizer can use the vehicle-integrated app to assign co-admin roles to other users, allowing them to share management responsibilities. If the organizer is out of range, she can remotely manage the event through cloud access, ensuring continuity. These capabilities prevent unauthorized users from controlling the event while ensuring quick admin recognition.

The vehicle can display a brief tutorial for new participants and allow the organizer to oversee participant engagement through a mobile app dashboard. If the organizer needs assistance managing the event, she can assign co-admin privileges to another person. This allows those with co-admin privileges to access the admin dashboard, monitor participant activity, and approve workspace modifications. If the organizer is out of range, the vehicle-integrated app can send her a notification prompting her to switch to a cloud-based remote admin mode, ensuring she can still manage the event. Unlike conventional keyless entry, this system enables role-based vehicle interaction, multi-admin privileges, and cloud-based remote management for event coordination.

The method can include, upon receiving the request to begin the schedule event, sensing, by a position sensor, a participant’s position. The method can include, upon sensing a participant’s position, assigning a display region on the exterior of the vehicle to the participant. The method can include, displaying a digital toolbox on the assigned display region. FIG. 2 shows an organizer and a participant near a vehicle with a digital toolbox displayed on two display regions, according to an embodiment.

The method can include, upon receiving the request to begin the schedule event, sensing, by a position sensor, multiple participants’ positions at the same time. The method can include, upon sensing participants’ positions, assigning a display region on the exterior of the vehicle to each participant. The method can include, displaying a digital toolbox on each of the assigned display regions.

In some embodiments, the vehicle computer system can detect, in real-time, the number of participants and their heights. For example, the vehicle computer system can use a surround multi-view camera (e.g., ADAS stereo cameras) and/or LIDAR sensors to detect the number of participants and their heights. The vehicle computer system can calculate each participant’s height in relation to the vehicle and can adjust user interface (UI) elements (e.g., the digital toolbox) dynamically. For example, taller users can see the UI elements positioned higher, while shorter users and children can see the UI elements lower. In some embodiments, the vehicle computer system can user a standardized arm-length estimation to determine an optimal UI positioning. The system and method can use real-time user height detection and/or artificial intelligence (AI)-based UI positioning adjustments.

As the users move around the vehicle, the vehicle computer system can continuously track their positions. In some embodiments, the vehicle computer system can include a gaze-based toolbox relocation. For example, if a user moves toward a different window (drawing workspace), the system can anticipate their intent by monitoring their gaze direction and movement pattern. If they glance at the digital toolbox for an extended period, it can highlight the edge of the toolbox (via a glow or bold outline) to get their attention. If they continue to gaze, the toolbox can automatically move closer to them. A popup window can provide manual control for confirming or adjusting the toolbox’s final position. Such features ensure an intuitive, ergonomic UI layout for users of different heights.

The method can include, in response to the participant touching the display region, displaying an image based on the participant’s touch in the display region. Participants can use the digital toolbox to select colors, brushes, shapes, icons, stickers, and effects, drawing directly on the vehicle windows. The digital toolbox can follow them as they move, ensuring tool accessibility. Users can use the digital toolbox to import photos from their phones/devices, crop them, and add frames. Users can also use the digital toolbox to export their displayed creations to their devices.

The system can differentiate between finger drawing (for precision) and palm press (for modifying elements). If a user wants to reposition their drawing, they may place their palm on the window, and the system recognizes their intent, allowing them to move it without erasing previous work. The system and method can include using sensor-based surface coverage detection to differentiate between finger drawing (fine detail) and palm press (move/reposition images). Multi-user concurrent input allows seamless collaborative drawing. The system and method can include hand gesture detection and/or artificial intelligence (AI) differentiation for intuitive user control.

The system can include a gesture-based object selection that recognizes palm placement for grouping. As participants work on different windows, they may want to relocate or expand their drawings. The sensors can enable a user to place their palm on their drawing, signaling the intent to move the drawing and/or digital toolbox. The system can detect this gesture and group the selection. The user then moves their hand toward another window, and the drawing follows them, allowing seamless repositioning. The system can include real-time user interface adjustment allowing dragging content across windows while maintaining proportionality.

The system can include a digital collision detection algorithm that automatically prevents overlaps with other drawings and provides a preview before confirming placement. The collision detection algorithm can prevent accidental overwriting. The system enables seamless repositioning of artwork without requiring manual erasing and redrawing. The system can use gesture tracking and object recognition to enable intuitive drawing relocation. Unlike static digital art tools, this system supports multi-surface, real-time movement of drawings.

The system can include optical flow sensors tracking foot movements and distinguishing between drawing and erasing actions. The system enables participants to use foot (or even hand) movements to create drawings on the ground via a laser projection system. The system can track foot gestures, allowing users to draw, erase, and modify content. The system can include AI-based smoothing ensuring that lines remain stable even on uneven surfaces.

If the user wants to erase a section, they can use a designated foot gesture (such as a swipe or stomp motion) to clear part of the drawing. The system can include AI-based line stabilization ensuring smoother strokes, compensating for uneven ground surfaces. In a further embodiment, the digital toolbox may continue to follow users by moving between window displays and ground displays, for example.

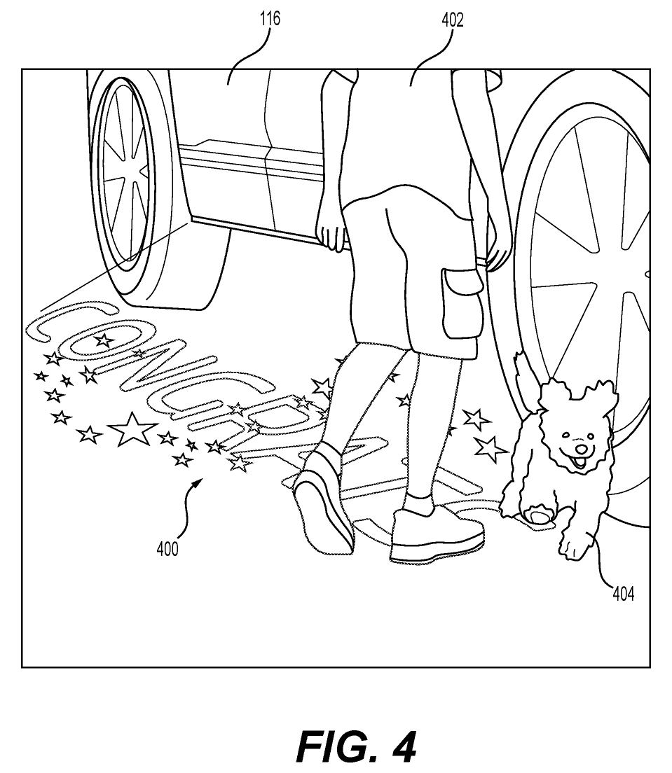

FIG. 4 shows participants creating images on display regions on ground around vehicle 116 with their feet as touch input, according to an embodiment. The ground around the vehicle is a fifth display region 400. A fourth participant 402 is a human using their foot to make a mural that says “congrats” on fifth display region 400. Participants can use the digital toolbox to select letters to print or to select a color to write/draw with. A fifth participant 404 is a dog running around vehicle 116. The dog’s steps can be tracked by the vehicle’s onboard ADAS sensors/cameras and can be used as input for creating stars on fifth display region 400. Alternatively, participant 404 may be a young child.

The interface on the window can provide an undo/redo function, allowing participants to refine their artwork without starting over. The undo/redo function can be enabled via an additional interface toolbox on the vehicle window, allowing real-time corrections. This function mitigates accuracy issues in foot-controlled digital drawing.

The system can include remote user synchronization allowing remote users to draw in real-time, displaying their input on the vehicle's windows through cloud-based rendering. For example, remote users can join in using their mobile devices.

The system can include AI-Based workspace allocation that can dynamically assign spaces based on participant activity, preventing workspace conflicts. The system can allow remote users to select an available workspace on the vehicle’s windows, ensuring they do not overlap with onsite participants. In some embodiments, the organizer can reserve space in the car windows in advance for remote users, marking those sections as "reserved" so onsite participants know not to use them.

The system can include collaborative mode activation allowing two users (onsite and remote) to merge workspaces with mutual approval. This collaborative mode can ensure a seamless and organized way for both onsite and remote users to collaborate without interference. This collaborative mode can use a cloud-based rendering system to synchronize remote input with real-time updates on the vehicle’s digital surfaces. Unlike typical remote collaboration tools, this system integrates real-time digital artwork creation across physical and virtual participants.

If a remote participant wants to collaborate with an onsite participant, the remote participant can send a request through the app, and the system can prompt the onsite user to approve the collaboration. Once approved, the remote user's drawings appear in real-time on the vehicle’s window, and both users can edit and expand the mural together.

The system can include facial recognition and identity verification. For example, the system can include the vehicle’s B-pillar facial recognition system to authenticate the designated recipient (e.g., the person whom the celebration is for, such as a graduate).

The method can include sequential content reveal that displays personalized messages as the designated recipient moves around the vehicle, ensuring a dynamic and interactive experience. The system can include real-time proximity-based activation that remains hidden until the designated recipient is detected within a predefined distance. The mural can remain hidden until the designated recipient is near the vehicle. The system can use a camera, such as the vehicle’s multi-view camera, to detect the designated recipient’s face and/or confirm the designated recipient’s identity through a facial recognition system, such as the vehicle’s B-pillar facial recognition system. Once the designated recipient is recognized and within a predefined distance, the vehicle can begin displaying the mural in a sequential reveal starting from where the designated recipient stands, showing personalized messages and animations as the designated recipient moves around the vehicle.

In some situations, as the designated recipient approaches a window, the message in front of her enlarges and can play associated effects or animations. If an unrecognized person attempts to trigger the reveal, the system remains inactive, ensuring the mural is only displayed for the intended recipient.

The facial recognition, identity verification, and proximity-based activation ensures that the surprise reveal is only triggered by the intended recipient.

Once the event/Family Mural activity is complete, the final artwork can be shared with other users (e.g., friends and family) who could not attend the event in person. The system can automatically compile all contributions, including onsite and remote participants’ drawings, into a final digital mural file. The compiled mural can be stored in in the organizer’s profile/account on the vehicle-integrated app, allowing easy sharing through a secure link. The vehicle-integrated app can store this information in a cloud computing environment.

The system can compile individual contributions into a time-lapse showing the creation process. The system can also record a time-lapse video showing how the mural was created, capturing the artistic process and interactions between participants. Additionally, the vehicle’s onboard cameras can document the intended recipient’s surprise moment during the reveal and a 360-degree reaction video can be created.

The final mural and recorded time-lapse video can be stored in the organizer’s profile/account on the vehicle-integrated app, allowing easy sharing through a secure link. The vehicle-integrated app can store this information in a cloud computing environment.

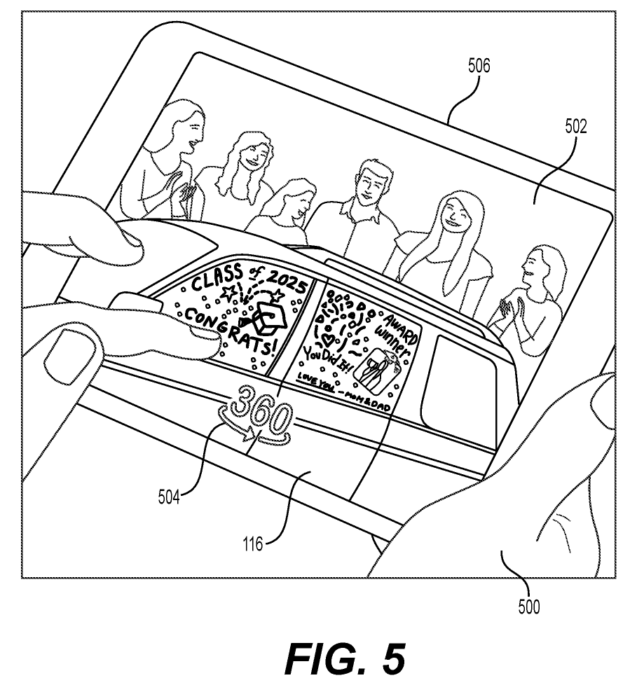

FIG. 5 shows a user 500 viewing an image 502 of vehicle 116 with display regions displaying a mural, according to an embodiment. The image 502 is displayed on a tablet 506. Image 502 includes a 360 tool 504 for allowing the user to view other perspectives of the scene shown in image 502.

The vehicle-integrated app can enable the transfer of the digital mural to another vehicle, such that the mural appears on a second vehicle that is different form the first vehicle that the mural was created on.

The vehicle-integrated app can allow the intended recipient to control how much of the mural is displayed. For example, the intended recipient can select parts of the mural to be displayed.

The vehicle-integrated app can have conditional display control allowing display of the mural under specified conditions. For example, the vehicle-integrated app can detect that the vehicle is stopped and allow the display to remain active. However, the system (e.g., by the vehicle’s environmental awareness system) can continuously monitor surrounding traffic and environmental conditions. If it detects moving vehicles nearby, the system can automatically disable the display to prevent distractions to other drivers. The system can use ADAS sensors and real-time traffic detection to dynamically enable or disable content visibility.

In another scenario, the system can momentarily allow static elements to be displayed when the vehicle is stopped at a red traffic light but disables them once the light turns green.

The intended recipient can activate “Parade Mode” through the vehicle-integrated app and show the mural off to friends as she comes near where her friends are gathered. The system can verify the surrounding conditions and make sure the vehicle is moving below a predefined speed threshold.

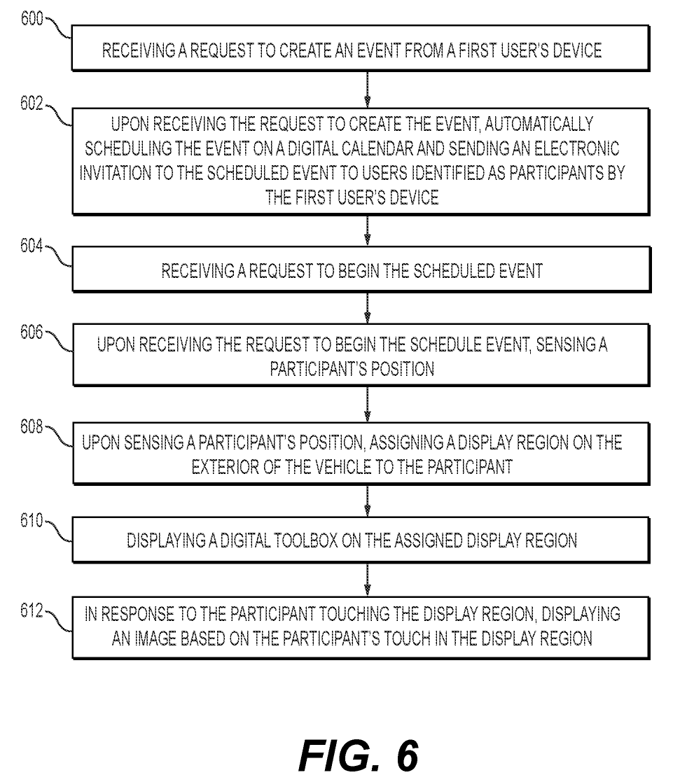

FIG. 6 shows a computer-implemented method of creating digital murals displayed on and around vehicles (or method), according to an embodiment. The method may include receiving a request to create an event from a first user’s device (operation 600). The method may include upon receiving the request to create the event, automatically scheduling the event on a digital calendar and sending an electronic invitation to the scheduled event to users identified as participants by the first user’s device (operation 602). The method may include receiving a request to begin the scheduled event (operation 604). The method may include upon receiving the request to begin the schedule event, sensing a participant’s position (operation 606). The method may include upon sensing a participant’s position, assigning a display region on the exterior of the vehicle to the participant (operation 608). The method may include displaying a digital toolbox on the assigned display region (operation 610). The method may include in response to the participant touching the display region, displaying an image based on the participant’s touch in the display region (operation 612).

Embodiments may also include one or more computers and one or more storage devices storing instructions that are operable, when executed by the one or more computers, to cause the one or more computers to perform the disclosed methods.

Certain embodiments may use cloud computing environments. Cloud computing environments can include, for example, an environment that hosts the services for impact analysis and detection described herein. The cloud computing environment may provide computation, software, data access, storage, etc. services that do not require end-user knowledge of a physical location and configuration of system(s) and/or device(s) that hosts the impact analysis and detection services. For example, a cloud computing environment may include a group of computing resources (referred to collectively as “computing resources” and individually as “computing resource”).

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

While various embodiments of the disclosure have been described, the description is intended to be exemplary, rather than limiting and it will be apparent to those of ordinary skill in the art that many more embodiments and implementations are possible that are within the scope of the disclosure. Various modifications and changes may be made within the scope of this disclosure.

We claim:

1. A computer-implemented method of creating a digital mural on a vehicle, comprising:
receiving, at a vehicle-integrated app, a request to create an event from a first user’s device;
upon receiving the request to create the event, automatically scheduling the event on a digital calendar and sending an electronic invitation to the scheduled event to users identified as participants by the first user’s device;
receiving, at the vehicle-integrated app, a request to begin the scheduled event;
upon receiving the request to begin the schedule event, sensing, by a position sensor, a participant’s position;
upon sensing a participant’s position, assigning a display region on an exterior of the vehicle to the participant;
displaying a digital toolbox on the assigned display region; and
in response to the participant touching the display region, displaying an image based on a participant’s touch in the display region.

2. The computer-implemented method of claim 1, wherein displaying an image based on the participant’s touch in the display region includes sensing, by a sensor, the participant’s touch.

3. The computer-implemented method of claim 1, wherein displaying a digital toolbox on the assigned display region includes a projector displaying the digital toolbox.

4. The computer-implemented method of claim 1, wherein displaying a digital toolbox on the assigned display region includes an interactive transparent window screen mounted on a window of the vehicle displaying the digital toolbox.

5. The computer-implemented method of claim 1, further including:
detecting, in real-time by a surround multi-view camera and/or a light detection and ranging sensor, the number of participants and their heights.

6. The computer-implemented method of claim 1, wherein assigning a display region on the exterior of the vehicle to the participant includes assigning a first display region to a first participant and assigning a second display region to a second participant, wherein the first display region and the second display region are both disposed on the exterior of the vehicle.

7. The computer-implemented method of claim 1, further including:
receiving from the first user, via the vehicle-integrated app, a request for permission to create an event for the vehicle.

8. A system for creating a digital mural on a vehicle, comprising:
one or more computers and one or more storage devices storing instructions that are executable by the one or more computers to:
receive, at a vehicle-integrated app, a request to create an event from a first user’s device;
upon receiving the request to create the event, automatically schedule the event on a digital calendar and sending an electronic invitation to the scheduled event to users identified as participants by the first user’s device;
receive, at the vehicle-integrated app, a request to begin the scheduled event;
upon receiving the request to begin the schedule event, sense, by a position sensor, a participant’s position;
upon sensing a participant’s position, assign a display region on the exterior of the vehicle to the participant;
display a digital toolbox on the assigned display region; and
in response to the participant touching the display region, display an image based on the participant’s touch in the display region.

9. The system of claim 8, wherein displaying an image based on the participant’s touch in the display region includes sensing, by a sensor, the participant’s touch.

10. The system of claim 8, wherein displaying a digital toolbox on the assigned display region includes a projector displaying the digital toolbox.

11. The system of claim 8, wherein displaying a digital toolbox on the assigned display region includes an interactive transparent window screen mounted on a window of the vehicle displaying the digital toolbox.

12. The system of claim 8, wherein the instructions are further executable by the one or more computers to:
detect, in real-time by a surround multi-view camera and/or a light detection and ranging sensor, the number of participants and their heights.

13. The system of claim 8, wherein assigning a display region on the exterior of the vehicle to the participant includes assigning a first display region to a first participant and assigning a second display region to a second participant, wherein the first display region and the second display region are both disposed on the exterior of the vehicle.

14. The system of claim 8, wherein the instructions are further executable by the one or more computers to:
receiving from the first user, via the vehicle-integrated app, a request for permission to create an event for the vehicle.

15. A non-transitory computer-readable medium storing software comprising instructions that are executable by one or more computers to create a digital mural on a vehicle by:
receiving, at a vehicle-integrated app, a request to create an event from a first user’s device;
upon receiving the request to create the event, automatically scheduling the event on a digital calendar and sending an electronic invitation to the scheduled event to users identified as participants by the first user’s device;
receiving, at the vehicle-integrated app, a request to begin the scheduled event;
upon receiving the request to begin the schedule event, sensing, by a position sensor, a participant’s position;
upon sensing a participant’s position, assigning a display region on the exterior of the vehicle to the participant;
displaying a digital toolbox on the assigned display region; and
in response to the participant touching the display region, displaying an image based on the participant’s touch in the display region.

16. The non-transitory computer-readable medium of claim 15, wherein displaying an image based on the participant’s touch in the display region includes sensing, by a sensor, the participant’s touch.

17. The non-transitory computer-readable medium of claim 15, wherein displaying a digital toolbox on the assigned display region includes a projector displaying the digital toolbox.

18. The non-transitory computer-readable medium of claim 15, wherein displaying a digital toolbox on the assigned display region includes an interactive transparent window screen mounted on a window of the vehicle displaying the digital toolbox.

19. The non-transitory computer-readable medium of claim 15, wherein the instructions are further executable by the one or more computers to:
detect, in real-time by a surround multi-view camera and/or a light detection and ranging sensor, the number of participants and their heights.

20. The non-transitory computer-readable medium of claim 15, wherein assigning a display region on the exterior of the vehicle to the participant includes assigning a first display region to a first participant and assigning a second display region to a second participant, wherein the first display region and the second display region are both disposed on the exterior of the vehicle.
